(19) United States
(12) Patent Application Publication
(10) Pub. No.: US 2007/0057798 A1
(43) Pub. Date: Mar. 15, 2007

(54) Vocalife line: a voice-operated device and system for saving lives in medical emergency

(76) Inventors: Joy Y. Li, New Providence, NJ (US); Lili Yan, Modesto, CA (US); Qi P. Li, New Providence, NJ (US)

Correspondence Address: Kao H. Lu, 4331 Stevens Battle Lane., Fairfax, VA, 22033, US

(21) Appl. No.: 11/223,490

(22) Filed: Sep. 9, 2005

(51) Int. Cl. G08B 23/00

(52) U.S. Cl. 340/573.1

(57) ABSTRACT

The invention, a voice-operated alarm system, includes an alarm and a receiver. The alarm is comprised of a microphone unit, a voice detector, a noise reduction unit, a speech recognizer or a keyword spotter which can recognize predefined keywords, and a signal transmitter. The speech recognizer and the keyword spotter can be speaker dependent, speaker independent, or both. A speaker-dependent system needs training, while a speaker-independent system does not. A receiver is located near the alarm and is connected to a telephone or data network. The receiver further communicates with the emergency monitoring center. Furthermore, the alarm system can also be implemented as a wireless phone with keyword spotting/recognition function. In this embodiment, the alarm user can communicate with the operators directly, like a cell phone, but the dial up function is replaced by uttering keywords. In this implementation, the receiver may not be necessary.

### FIELD OF INVENTION

This invention relates to a medical emergency alarm system. More particularly, this invention is in the field of voice-operated emergency alarm systems.

### BACKGROUND OF THE INVENTION

When an emergency occurs, especially for someone with preexisting medical problems, whose medical problem unexpectedly worsens, one's life depends on how quickly one can get medical help. In general, this group of people lives a normal life outside the hospital, but carries a mobile medical emergency alarm (the alarm) with them at all times so that in case of emergency, the alarm user can active the alarm and send out emergency signals for help. Usually, the medical emergency alarm system includes at least one mobile user-carried medical emergency alarm and one receiver located nearby. In the simplest set up, the alarm system has one alarm and one receiver. Upon activation by the user during an emergency, the alarm sends out signals to the nearby receiver, which is similar to the base unit of a cordless phone in function and size that in turn is connected to the telephone or data network directly.

Next, through the receiver, the emergency signals will be transmitted to an emergency monitoring center where operators stand by day and night to handle incoming emergency calls. From the received emergency signals, the operator can identify where and from whom the emergency signals are coming and will try to get in contact with the caller, usually through the phone system, to further investigate the incident. If the operator can't get in touch with the caller, the operator will assume that an emergency has happened to the caller and the caller is badly in need of help. Therefore, the operator will dispatch an ambulance to a pre-determined location, presumably the caller's home, to help the caller.

The mobile medical emergency alarms used in the current market are either a sensor-based alarm or a push-button based alarm. The sensor-based alarm is equipped with different sensors to monitor the occurrence of different, specific abnormal conditions. For example, one sensor may be set up to monitor any sudden falls of the user. If the user unexpectedly loses balance and falls down accidentally, the falling impact will active the alarm to send out an emergency signal to the monitor center. Depending on the needs, the sensor-based alarm can be customized to be equipped with different sensors to monitor different variables, such as body temperature, heart beats or other vital signs of the user. Once the sensor detects an abnormal condition occurred it will invoke the alarm, and the alarm system will automatically send emergency signals out to a designated monitoring center, which will notify the police or dispatch an ambulance to the location to help the user. However, multi-purpose sensor-based alarms can be expensive. At the same time, the push-button based medical alarm requires that in case of emergency, the alarm user must push a designated button on the alarm to active the alarm and send the emergency signal out to the monitor center.

However, there are abnormal conditions that are not covered by the built-in sensor-based alarm, or the push-button based alarm holder may, for some reason, be incapable of pushing the emergency button on the alarm to ask for help. So there is a need for a voice-operated alarm system that will help the user if help is required. In this case, a user using a voice-operated alarm system can utter keywords to active the alarm, which can then send emergency signals calling for help.

Due to the recent advancements of the automatic speech recognition (ASR) technology and the keyword spotting technique, it is feasible to implement the ASR and keyword spotting algorithms in a small device, which can recognize verbal keywords uttered by users. The voice-operated alarm system with a built-in ASR can make the usage of medical alarm systems more flexible and user-friendly. When the voice-operated device detects a pre-defined keyword or a combination of keywords, such as “help, help” or a special sound(s) from a user, it will active the alarm and in turn send emergency signals to a receiver. The receiver then automatically dials an operator at the emergency monitoring center. Furthermore, the voice-operated alarm can also have the sensors and the button if needed to give users more choices.

### SUMMARY OF THE INVENTION

The invention, a voice-operated alarm system, includes an alarm and a receiver. The alarm is comprised of a microphone unit, a voice detector, a noise reduction unit, a speech recognizer or a keyword spotter which can recognize predefined keywords, and a signal transmitter. The speech recognizer and the keyword spotter can be speaker dependent, speaker independent, or both. A speaker-dependent system needs training, while a speaker-independent system does not. A receiver is located near the alarm and is connected to a telephone or data network. The receiver further communicates with the emergency monitoring center. Furthermore, the alarm system can also be implemented as a wireless phone with keyword spotting/recognition function. In this embodiment, the alarm user can communicate with the operators directly, like a cell phone, but the dial up function is replaced by uttering keywords. In this implementation, the receiver may not be necessary.

### BRIEF DESCRIPTION OF THE DRAWING

FIG. 1 is an operation overview between the medical alarm system and the monitoring center.

FIG. 2 is a functional block diagram of the present invention.

FIG. 3 is a logical flowchart to illustrate the operations of the invention.

### DETAILED DESCRIPTION OF THE PREFERRED EMBODIMENT

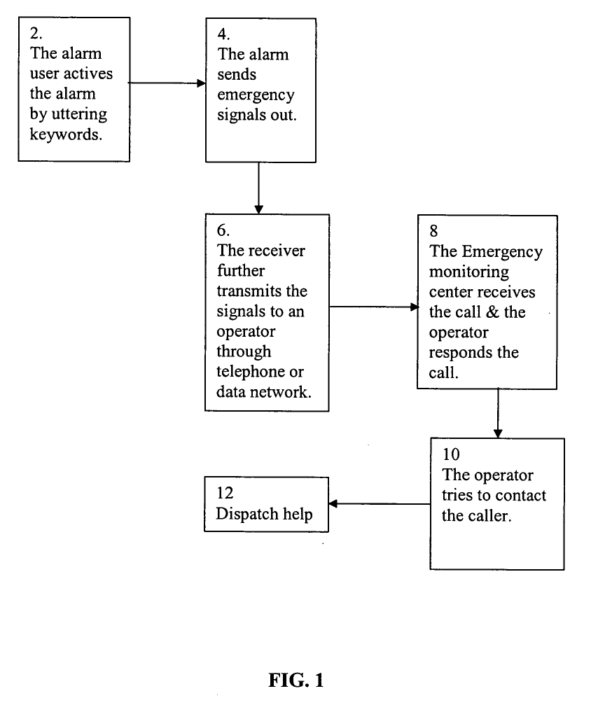

FIG. 1 illustrates an example of an operation overview between the alarm and the monitoring center. During the emergency, the alarm user will speak verbal keywords calling for help. These designated keywords will invoke the voice-operated alarm to send out emergency signals to a receiver Steps 2, 4. The receiver either goes through a telephone or data network sending the necessary emergency signals to the monitoring center Step 6. Because the emergency signals contain identification information, in Steps 8 and 10 the alerted operator at the center has the means to identify the caller and will try to get in contact with the caller's home immediately, to verify the emergency situation. If the operator can't get a response from the caller, the operator will dispatch an ambulance to the caller's location or inform the police accordingly Step 12.

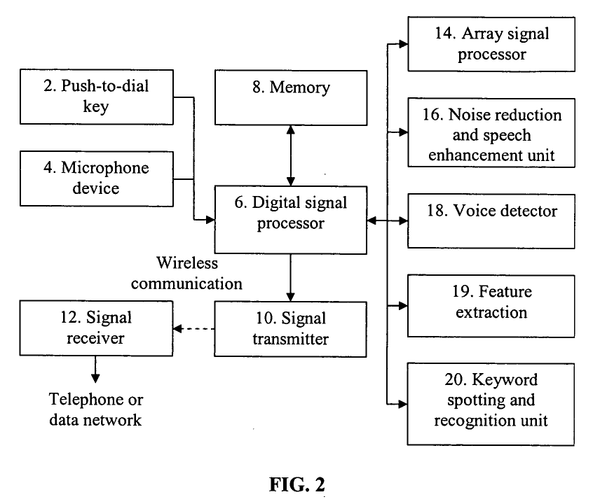

FIG. 2 illustrates functional blocks of a voice-operated alarm; the alarm has an optional emergency button too, which the user can push to make an emergency call. The alarm is equipped with a microphone or microphone array 4 for voice input, a signal microprocessor 6, memory 8 (read-only, random-access, or flash memory as needed), an array signal processing unit (ASPU) 14, a noise-reduction and speech enhancement unit (NRU) 16, a voice detector unit (VDU) 18, a feature extraction unit (FEU) 19, keyword sporting and recognition unit (KSRU) 20, and a signal transmitter 10. The button, microphone/microphone array, SPU, memory, NRU, ASPU, VDU, FEU, KSRU, and the signal transmitter are all connected to the signal microprocessor. Furthermore, there is a signal receiver 12 that can receive the emergency signal from the alarm device and automatically dial an operator in a service center.

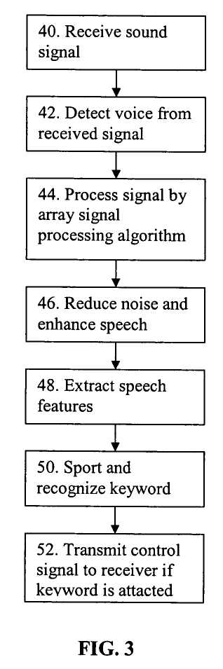

FIG. 3 is a logical flowchart to illustrate the operations of the invention. Sound is received by the built-in microphone in the alarm (Step 40). The voice activity detector monitors the input sound signal all the time and computes the energy levels and the dynamic changes of the energy of the input signal. When the energy of the input signal looks like a speech signal, the voice activity detector turn on the built-in automatic speech recognizer or keyword spotter. When the input sound does not like voice, the alarm can be in a sleep mode to reduce the power consumption.

The input analog signals, are collected by a microphone component or a microphone array. The microphone array includes more than one microphone component. Each microphone component is coupled with an analog-to-digital converter (ADC), the ADCs convert the received analog voice signals into digital signals and forward the output to an array signal processing unit, where the multiple channels of speech signals are further processed using an array signal processing algorithm and the output of the array processing unit is one channel of speech signals with improved signal-to-noise ratio (SNR) (Step 44). Many existing array signal processing algorithms, such as the delay-and-sum algorithm, filter-and-sum algorithm, adaptive algorithms, or others, can be implemented to improve the SNR of the input signals. The delay-and-sum algorithm measures the delay on each of the microphone channels, aligns the multiple channel signals, and sums them together at every digital sampling point. Because the speech signal has a very large correlation at each of the channels, the speech signal can be enhanced by the operation. At the same time, the noise signals have less, or no, correlation at each of the microphone channels; when adding the multiple-channel signals together, noise signals can be cancelled or reduced.

The filter-and-sum algorithm is more general than the delay-and-sum algorithm, which has one digital filter in each input channel, plus one summation unit. In our invention, the array signal processor can be a linear or nonlinear device. In the case of a nonlinear device, the filters can be replaced by a neural network or a nonlinear system. The parameters of the filters can be designed by existing algorithms or can be trained in a data driven approach that is similar to training a neural network in pattern recognition. In another implementation, the entire array signal microprocessor can be implemented as a neural network and a multi-input-one-output system, and the network parameters can be trained by pre-collected or pre-generated training data.

Moreover, because the microphone array consists of a set of microphones that are spatially distributed at known locations with reference to a common sound source, the invention can implement an array signal processing algorithm, by weighting the microphone outputs, and an acoustic beam can be formed and steered to the directions of the source of the sound, e.g. speaker's mouth. Consequently, a signal propagating from the direction pointed by the acoustic beam is reinforced, while sound sources originating from directions other than the direction are attenuated; therefore, all the microphone components can work together as a microphone array to improve the signal-to-noise ratio (SNR). The microphone array can find the source of the sound and can follow the sound's location by an adaptive algorithm. The output of the digital array signal microprocessor is one-channel digitized speech signals where the SNR is improved by an array signal processing algorithm with or without adaptation.

Referring back to FIG. 3, the single channel speech signals transmitted from the array signal processing unit or a microphone component are then forwarded into a noise-reduction and speech-enhancement unit (Step 46) where the background noise is further reduced as the speech signal is simultaneously enhanced by a single-channel signal processing algorithm, such as a Weiner filter, auditory-based algorithm, spectral subtraction, or any other algorithms that can improve the SNR with less or no distortion on the speech signals (Step 46). The output of this unit is one-channel enhanced speech signals.

In both keyword spotting and speech recognition, the input speech signal is first converted into acoustic features in the frequency domain. This step is called feature extraction Step 48. Although any algorithm can be used in the step, we prefer auditory-based algorithms that convert input time-domain signal into frequency-domain feature vectors by simulating the function in human auditory system. The noise reduction (Step 46) can be implemented independently or in combination with this feature extraction step.

The speech feature from Step 48 is then forwarded to a keyword spotting or speech recognizer unit 20 (Step 48). Keyword spotting is the algorithm of spotting keywords from the input speech signal while the speech recognizer converts the input speech signal into text. When the keywords are spotted or recognized, a control signal can be transmitted from the alarm to the receiver 12 to dial an operator Step 52.

In the keyword spotting algorithm, there are two kinds of statistical models: keyword models and garbage models. The keyword models are used to model the acoustic characteristics of the keywords while the garbage models are used to model all sounds, voice and noise, other than the keywords. During a decoding process by using a search algorithm, such as the Viterbi algorithm, the input feature vectors from Step 48 are compared with the keyword models and the garbage models. If the features match the keyword models better than the garbage models, a keyword is found and a control signal is transmitted to the receiver 12; otherwise, there is no keyword in the feature vectors and the decoding process keeps searching and comparing. The degree of match between the model and feature vectors is measured by computing likelihood scores or other kind of score during searching. When the feature vectors match the acoustic keyword models, the keyword is found. Consequentially, this will invoke the alarm to send out emergency signals to the device 12.

In speech recognition algorithms, there are phonemes or speech sub-word models to represent the characteristics of spoken words. Those models are pre-trained by labeled speech data. During a decoding process, the feature vectors from Step 48 are compared with the pre-trained acoustic models and pre-trained language models which represents the constrains of a language grammar. Basically, the feature vectors of an uttered speech keyword are compared with the acoustic models using a searching algorithm or detection algorithm, such as the Viterbi algorithm. The degree of match between the model and feature vectors is measured by computing likelihood scores or other kind of score during searching. When the feature vectors match the acoustic models of the keyword, the keyword is found. Consequentially, this will invoke the alarm to send out emergency signals to the device 12.

The statistical acoustic models in either the keyword spotting algorithm or the speech recognition algorithm can be speaker dependent or speaker independent. In the case of speaker dependent, the models are trained based on the user's voice of the keywords or other sounds, so the alarm only words for the particular user. In the case of speaker independent, the models are trained based on many users' voices, so the trained models can generally match any users' voice and the alarm can work for any user without any training. A speaker dependent alarm can be adapted from a speaker independent alarm by asking the user to do utter the keywords for several times for training.

The transmitted control signals from the alarm to the device can be in any frequency bands, such as in the frequency bands of cordless phones, the Wi-Fi bands, or any wireless signal bands. The transmitted information can be coded for in any method for any reason.

The alarm can also be implemented as a wireless phone, but replacing the key pad dialing by keyword uttering. In this implementation, the operator can talk with the user directly and the receiver can be eliminated.

I claim:

1. A system for communications in a medical emergency situations between a user and a monitoring center comprising:
a voice-operated device that can recognize predetermined voice keywords uttered by the user then wirelessly sends predetermined emergency signals out;
a receiver to receive the emergency signals from the voice-operated device; and
through a telephone or a data network, the receiver will sends a emergency call to the monitoring center.

2. The system as claimed in claim 1, wherein the user utters the predetermined keyword(s) by the user's own voice to active the voice-operated device.

3. The system as claimed as claim 1, wherein the predetermined keyword(s) can be spoken by any person to active the device.

4. The system as claimed in claim 1, wherein the receiver can be a wireless station located next to the voice-operated device as the base of a cordless phone, where the voice-operated device can be a wireless phone dialed by uttering the keywords.

5. A voice-operated device used for calling a monitoring center at a medical emergency comprising:

6. a microphone unit for receiving voice input;
a signal microprocessor to process the received voice input;
a plurality of memories comprised of RAM and ROM;
a radio-frequency transmitter to send out a plurality of predetermined wireless signals;
a battery power source; and
upon receiving a recognized predetermined voice keyword, the device automatically sends out a plurality of predetermined wireless emergency signals.

7. The device as claimed in claim 4, wherein further comprising an optional key that can be pushed by a user to send out the wireless emergency signals.

8. The device as claimed in claim 4, wherein the microphone unit is a microphone or a microphone array comprised of more than one microphone component.

9. The device as claimed in claim 4, wherein the signal processor further comprising:
a plurality of preamplifiers, where each preamplifier has a corresponding voice signal channel, amplifying analog signals received from microphone unit;
an analogue-to-digital converter (ADC) to convert the received analogue signal into a digital signal;
a voice detector to detect voices from silence and to trigger speech signal processing;
an array signal unit to improve signal-to-noise ratio (SNR) and to convert received multiple-channel signals into single-channel signals;
a noise-reduction and speech enhancement unit to further improve the single-channel SNR; and a keyword-spotting unit to spot and recognize the keywords from received signals.

10. The device as claimed in claim 4, wherein the signal processor can be implemented by one semiconductor chip or more than one chips.

11. The array signal unit as claimed in claim 7, wherein further implementing an array signal processing algorithm, such as a delay-and-sum algorithm, a filter-and-sum algorithm, a linear algorithm, or a nonlinear algorithm.

12. The array signal unit as claimed in claim 9, wherein the nonlinear algorithm further including one or more nonlinear functions, such as a sigmoid function.

13. The signal processor as claimed in claim 7, wherein the noise reduction and speech enhancement unit further implementing a Weiner filter algorithm or a spectral subtraction algorithm or any noise reduction to further reduce noise and enhance speech of the signals.

14. The signal processor as claimed in claim 7, wherein the noise reduction and speech enhancement unit further implementing an auditory-based algorithm to further reduce noise and enhance the speech of the signals.

15. The signal processor as claimed in claim 7, wherein the keyword-spotting unit further comprising:
a feature extracting unit to convert time-domain speech signals into frequency-domain feature vectors for recognition;
acoustic models representing phonemes, sub-words, keywords, and key-phrases which need to be spotted;
a garbage model representing all other acoustic sounds or units; and
and a decoder that can distinguish keywords or commands from voice signals through searching and using the models.

16. The signal processor as claimed in claim 7, wherein the keyword-spotting unit further comprising:
a feature extracting unit to convert time-domain speech signals into frequency-domain feature vectors for recognition;
a language model to model the statistical property of spoken languages to help in search and decoding;
a set of acoustic models to model acoustic units: phonemes, sub-words, words, or spoken phrases, where the model can be a hidden Markov model or a Gaussian mixture model to model the statistical property; and
a decoder to convert a sequence of speech features into a sequence of acoustic units by searching, and then mapping the recognized acoustic units to keywords, text, or control signals.

17. The signal processor as claimed in claim 7, wherein the keyword-spotting unit can be a speech recognizer that recognizes the keyword automatically.

18. The voice-operated device as claimed in claim 5, wherein the transmitter sends out the same predetermined emergency signals either invoked by pushing the key or by uttering keyword(s).
